(19) United States
(12) Patent Application Publication
(10) Pub. No.: US 2009/0194201 A1
(43) Pub. Date: Aug. 6, 2009

(54) METHOD AND APPARATUS FOR CUTTING

(76) Inventor: Andrew Karl Knorr, Victoria (AU)

Correspondence Address: SCHMEISER OLSEN & WATTS, 18 E UNIVERSITY DRIVE, SUITE # 101, MESA, AZ, 85201, US

(21) Appl. No.: 11/913,549

(22) PCT Filed: May 2, 2006
(86) PCT No.: PCT/IB06/01120

§ 371 Date: May 21, 2008

(30) Foreign Application Priority Data
May 2, 2005 (AU) 2005902197

(51) Int. Cl. B27B 1/00; B27B 7/00

(52) U.S. Cl. 144/378; 144/176; 144/3.1

(57) ABSTRACT

A cutting-apparatus is used to slice a plurality of timber-sections from a log-segment that has a wedge-shaped cross-section. Before the step of slicing the log-segment into the individual timber-sections, there is a prior step of cutting a shape and configuration into the bark-edge-region of the log-segment. This includes cutting the intended outer profiles of timber-sections that eventually will be sliced from the segment. Thereafter, slicing the elongated segment produces timber-sections which have their cross-sections and edges already fully formed by the prior cutting step. The shape and configuration, that is pre-cut into the bark-edge-region, comprises a plurality of edge-face-cuts.

### FIELD OF INVENTION

The present invention relates to a method and apparatus that cuts a segment of a tree log (log-segment) into a plurality of elongated timber-sections.

### BACKGROUND OF THE INVENTION

By way of background, FIG. 1 shows a cross-sectional view of a perfectly straight log of which its cross-section has been cut into wedge-sections 10. Each wedge-section 10 has radial faces 15. The planes 16 (shown by dotted lines), which are formed by the radial faces 15, meet at an apex 20. In practice, the physical apex may be missing due to rot or splitting. The outer semi-circular rim 25 of the wedge consists of the bark-edge, which is the natural edge of the timber.

The cross-sections of large trees typically have concentric annular growth rings 30.

FIG. 1A shows part of the full elongated log-segment 11, which has the wedge-shaped cross-section 10, with radial faces 15 on the sides. The curved surface 10A of the segment represents the natural bark-edge of the log.

In the prior art, an end goal is to produce conventional quarter-sawn timber-sections shown in FIG. 2. (In industry, the timber-sections are typically in the form of boards, and the faces of these boards are sometimes referred to as “radial faces” 35, however, in the quarter-sawn timber-sections, the planes 36 of the faces 35 do not meet at an apex. Hence, in this specification, the term “radial” will not be used in this sense, but rather will refer to surfaces that radiate from a central apex. FIG. 2 shows the annual growth rings 30 of the wood.

Tree logs are not always perfectly straight, and can have curvature. Consequently, a cut, that is required to extract a wedge from the timber, may be perfectly aligned at one part of the log (as in FIG. 1) may be misaligned at another part of the same log (as in FIG. 3). FIG. 3 shows that a bent log can cause the cutting-centre 40 to shift away from the true centre 42 of the cross-section of the log. The annular rings are usually perpendicular to the radial faces of the wedges, however, in some circumstances (for example, at the location of reference numeral 41) the rings may be tangential to the radial face of the wedge.

Each wedge is generally shaped as a sector, although in some cases, such as in FIG. 4, it is not the natural sector emanating from the centre point of the log's circular cross-section, since the radial faces can sometimes be pared back. In FIG. 4, a wedge-section 10 can be created by removing two quarter-sawn portions that are removed as indicated by tine dotted lines 16, thereby leaving behind a wedge-section 10.

In prior art FIG. 5, converting the wedge into timber-sections involves firstly slicing the wedge along the dotted lines 130, leaving a small curved piece of timber 55 at the top. In FIG. 5, the small piece 55 has a shell-like or lens-like cross-section, and has no side-faces. In this form, it is not usable as a timber-section. If it is desired to convert that small curved piece of timber 55 into a useable shape, a subsequent operation is required to handle and machine that piece. To convert that piece into one having a rectangular cross-section, the operation can involve several extra steps, namely: separating the piece 55 from the wedge, cutting off its sides, and cutting off its top surface to create a flat top. In some cases, these extra steps are considered uneconomical, and so these smaller pieces of timber 55 are discarded and wasted. As the angle 60 between the radial faces increased, there is also an increase in the percentage of timber in this round section 55 of the wedge. Hence, wastage increases as the angle 60 of the wedge increases.

In FIG. 5, the piece 56, which is directly underneath the small curved piece 55, is also not in a useable form because of the rim edge 57 of the wedge. This also would require extra steps to convert into a useable board, and these extra steps add to the cost of production. Since the size of the rim edge 57 will vary along the length of the board, it can be difficult to efficiently cut the rim edge from the timber-section. Sometimes, sections of pieces may be discarded as waste because the extra steps are considered uneconomical.

FIG. 6 shows another prior art approach to cutting out timber-sections from a wedge. A radial wedge-section is cut along dotted lines 130 to form quarter-sawn timber-sections, however, the central remaining small wedge 66 is often discarded because it is often uneconomic to take the extra steps to convert that into a useable shape. Moreover, the limber-sections that are sliced according to the lines 130 in FIG. 6 are not yet in saleable form, because each timber-section still retains a small portion of the bark-edge 10A. Hence, yet a further processing step is required to turn these into saleable timber-sections, which adds to time and cost of production.

In the prior art, the discarding of smaller pieces of irregular-shaped timber, which could otherwise be made into saleable product, is a source of inefficiency and wastage. These small pieces of timber are currently often discarded because the existing methods for processing these small pieces of timber are often regarded as uneconomic.

An object of the present invention is to overcome or at least ameliorate one or more of the problems in the prior art, or to provide an improved alternative.

Discussion of prior art in this specification, either individually or in combination, should not be construed as an admission of the state of common general knowledge of the skilled addressee, unless specifically admitted, as is the case of the conventional quarter-sawn timber-sections in FIG. 2.

### SUMMARY OF INVENTION

According to the present invention, there is provided a method of using a cutting-apparatus to cut a plurality of elongated timber-sections from an elongated log-segment that has a wedge-shaped cross-section defined by two non-parallel radial faces with an angle therebetween bisected by a central-plane, and that also has a curved bark-edge-region, the method comprising the steps of:

initially pre-cutting, into the bark-edge-region, a shape and configuration that includes outer profiles of one or more elongated timber-sections that eventually will be sliced from the elongated log-segment,

and slicing the elongated log-segment such that the timber-sections so produced have their cross-sections and edges already fully formed by said initial pre-cutting step,

wherein the shape and configuration, that is pre-cut into the bark-edge-region, comprises a plurality of edge-face-cuts that are defined by one or more of the following:

i) the edge-face-cut is not parallel to the radial faces; and

ii) the edge-lace is not perpendicular to the central-plane that bisects the angle which is between the two radial faces.

One or more of the edge-face-cuts may be parallel to the central-plane of the wedge-shaped cross-section.

One or more of the edge-face-cuts may not he parallel to the central-plane of the wedge-shaped cross-section.

More than one of the edge-face cuts may be concurrently pre-cut into the bark-edge-region.

The cutting-apparatus may have simultaneous-pre-cutting-means to concurrently make two or more of the edge-face cuts.

Preferably, the simultaneous-pre-cutting-means of the cutting-apparatus can concurrently make all the edge-face cuts in one pass of the apparatus along the elongated log-segment.

The initial pre-cutting into the bark-edge-region of the elongated log-segment may occur either after the elongated log-segment has been cut out of its log, or alternatively before the elongated log-segment has been cut out of its log.

Preferably, the radial faces generally form a V-shape that converges at an apex.

The apex may or may not be physically present depending on the quality and condition of the wood material.

The angle between the radial faces may be substantially less than 180 degree to form said wedge-shaped cross-section.

The method may include pre-cutting one or more planes in the bark-edge-region that are perpendicular to the central-plane so as to create one or more flat-faces on the bark-edge-region.

The edge-face-cuts may be adapted to become square-edges and/or bevelled-edges in the resulting timber-sections.

The cutting apparatus may be adapted to make the plurality of edge-face cuts in the bark-edge-region along the elongated log-segment such that each in a series of the edge-face cuts follows a line that, along the length of the elongated log-segment, is equidistant from the apex.

The cutting apparatus may be adapted to make the plurality of edge-face cuts in the bark-edge-region along the elongated log-segment such that each in a series of the edge-face cuts follows a line that, along the length of the elongated log-segment, is parallel to the apex.

The elongated log-segment may have a bark-edge surface which has a longitudinal curvature along the elongated log-segment, and wherein the cutting apparatus is adapted to make the plurality of edge-face cuts in the bark-edge-region along the elongated log-segment such that each in a series of the edge-face cuts follows a line that, along the length of the elongated log-segment, follows the longitudinal curvature of the bark-edge surface.

According to another aspect of the present invention, there is provided a cutting system adapted to cut a plurality of elongated limber-sections from an elongated log-segment that has a wedge-shaped cross-section defined by two non-parallel radial faces with an angle therebetween bisected by a central-plane, and that also has a curved bark-edge-region, the system comprising:

pre-cutting-means adapted to cut, into the bark-edge-region, a shape and configuration that includes outer profiles of one or more elongated timber-sections that eventually will be sliced from the elongated log-segment, and

slicing-means adapted to slice the elongated log-segment such that the timber-sections so produced have their cross-sections and edges already fully formed by said initial pre-cutting step,

wherein the pre-cutting-means is adapted to cut the shape and configuration in the form of a plurality of edge-face-cuts that are defined by one or more of the following:

i) the edge-face-cut is not parallel to the radial faces; and

ii) the edge-face is not perpendicular to the central-plane that bisects the angle which is between the two radial faces.

According to a further aspect of the invention, there is provided a timber-product comprising at least two timber-section that is sliced from an elongated log-segment according to the above method, wherein broad faces of the two timber-sections are fastened together such that the growth rings of each timber-section is opposed to the other in order to counteract any cupping tendency in the material of the timber-sections.

The limber-sections may have growth rings that are generally transverse to the broad face of the timber-section.

The timber-sections may have growth rings that are generally parallel to the broad face of the timber-section.

The growth rings of the two timber-sections may be symmetrically opposed to each other in terms of direction of curvature of the growth rings, and not in terms of mirror-like identicalness.

The growth rings may have a generally concave arrangement such that the concave portions of the two timber-sections symmetrically face each other.

The growth rings may have a generally concave arrangement such that the concave portions of the two timber-sections symmetrically face away from each other.

The two timber-sections may be fastened together by any one of: glue, adhesive, nails, screws, or other mechanical or chemical fastening means.

Other preferred features are recited in the appended subsidiary claims, and their subject matter is imported into this summary by reference as preferred or modified features.

In the embodiments, before slicing the wedge into elongated timber-sections, there is the prior step of pre-cutting, into the bark-edge-region, a shape and configuration that consists of the intended outer shapes of the combination of the timber-sections. Hence, when the wedge is ultimately sliced into individual timber-sections, the end-products have their cross-sections already fully formed or sized. There is no need to further cutting of the individual timber-sections.

An advantage is that the fully-formed timber-sections, shaped with their ultimate cross-sections, can be created in one slicing operation, given the appropriate slicing machinery.

Another advantage is that the ultimate cross-sections of the fully-formed timber-sections can be created, before the wedge is sliced into individual timber-sections, by machining the outer surface of the large pre-sliced wedge. This is an advantage because it avoids the more intricate and costly operation of having to individually cut the smaller timber-sections in a post-slicing operation. It is more efficient to use one operation to pre-cut the outer bark-edge-region of a large wedge into the combined shapes of a plurality of timber-sections, and then to slice the wedge, as compared to individually shaping each of the smaller timber-section pieces after the wedge has been sliced.

A further advantage is that it saves time and cost, because the pre-cutting the outer bark-edge-region of the wedge is suited to being achieved in one step or one pass of a cutting machinery that has multiple blades. One set of machinery can be used for this, because it avoids the extra cost of providing further machinery to cut and shape the individual sliced timber-sections. The number of workmen can thus be reduced, since further workmen are not needed for a post-slicing operation.

The method effectively pre-creates finished timber-section-profiles in the bark-edge-region, before the timber-sections are actually separated from the wedge by slicing.

The term “bark-edge” is the natural edge of the log surface. When the bark is stripped away from the tree, immediately under the bark is the beginning of the actual wood material. The outer surface is the timber material is defined here as the “bark-edge”. In other words, the bark-edge is not the actual bark itself.

Therefore, the corresponding term “bark-edge-region” includes the bark-surface, and in addition also includes the region of wood that is immediately under or adjacent to the bark-edge. The invention is focused on a method and apparatus for cutting this bark-edge-region.

In this specification, the term “segment of a log” is used interchangeably with the term “log-segment”, which are intended to have the same meaning.

### DRAWINGS

The following six diagrams have been used above to discuss the background to the invention:

FIG. 1 shows a cross-sectional view of a perfectly straight log that has been cut into wedge-sections;

FIG. 2 shows a conventional quarter-sawn limber-section that is cut from the cross-section of a timber log;

FIG. 3 is a cross-sectional view of another pan of a log, showing how curvature in the log can cause the cutting-centre to shift away from the true centre of the cross-section of the log;

FIG. 4 shows another manner in which a wedge can be formed, by removing pieces from the radial edges of the original wedge to form a smaller wedge;

FIG. 5 shows a prior art approach to cutting timber-sections from a wedge which leaves extra pieces that are often uneconomic to process further; and

FIG. 6 shows another approach in the prior art for cutting timber-sections from a wedge, with consequential wastage of a small wedge.

In order that the present invention might be more fully understood, embodiments of the invention will be described, by way of example only, with reference to the accompanying drawings, in which:

FIG. 7 shows a cross-sectional view of a first embodiments of an elongated segment of a log that have been cut according to an embodiments of the invention;

FIG. 8 shows a cross-sectional view of the small piece taken from the segment in FIG. 7, indicating how the side bevels enable a larger end-product (in this case, a floorboard) to be made from the bevel-edged timber-section.

FIG. 9 shows a cross-sectional view of an other embodiments of elongated segments of logs, in which the slices are cut in a plane that is parallel to the central-plane;

FIG. 10 shows a cross-sectional view of another embodiment in which only edge-faces, that are parallel to the central-plane, have been provided, and that no bevelled edge-faces have been provided;

FIG. 11 shows a further embodiment of a cross-sectional view of an elongated segment of a log that is partially cut, in accordance with an embodiment of the invention (the diagram is used to define the scope of the angles of the edge-faces);

FIG. 12A shows a plan view of a log that is not perfectly straight;

FIG. 12B shows a side-end view of the log of FIG. 12A, with a further cross-section of the same log shown also in dotted lines;

FIGS. 13A, 13B, 13C and 13D each show a side view of an elongated segment of a log, where edge-faces have been pre-cut into the bark-edge-region, based on different embodiments of cutting technique;

FIG. 14A shows a side view of an apparatus that transfers and positions the timber-sections;

FIG. 14B shows a plan view of the apparatus of FIG. 14A which transfers and positions the timber-sections;

FIGS. 15A, 15B and 15C show side views of several embodiments of apparatus that transfer the timber-sections;

FIGS. 16A, 16B and 16C show side-views of various embodiments of apparatus that are used to produce the profiled wedge-sections and the sliced timber-sections;

FIG. 17 shows a sorting, stacking and docking system that takes advantage of efficiencies in production that are made possible by the method of profiling the bark-edge-regions of the wedge-sections;

FIG. 18A shows a timber-product that comprises two backsawn timber-sections that have been laminated together (laminate); and

FIG. 18B shows a quartersawn laminate that balances natural characteristics of the timber-sections.

In the embodiments, some of the like feature have been labelled with like reference numerals merely for ease of understanding the different embodiments.

### DESCRIPTION OF EMBODIMENTS

### 1^{st} Embodiment

Referring to the accompanying drawings, the present embodiment involves culling a plurality of elongated timber-sections from an elongated segment of a log.

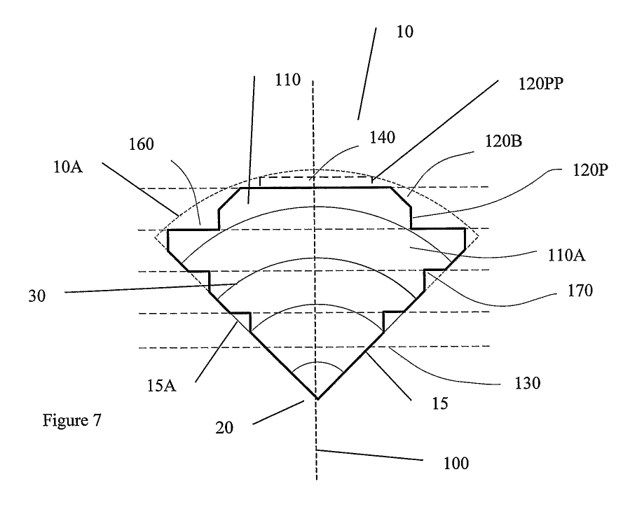

FIG. 7 shows a cross-sectional view of an embodiment of an elongated segment of a log, which has been pre-cut according to an embodiment of the present invention. FIG. 7 provides an overview of features of embodiments of the present invention.

In FIG. 7 dotted lines show the cross-section of an elongated log-segment that originally had a wedge-shaped cross-section (the original cross-section, prior to pre-cutting, is shown by the dotted line 10A and 15A).

The wedge-shaped cross-section, in the original segment, is defined by two non-parallel radial faces 15. The angle that is between the radial faces is bisected by a central-plane 100.

The planes, which were formed by the radial faces 15, met at an apex 20. In practice, the physical apex of the wedge may be missing due to the quality and condition of the wood material. Hence, the apex may also be defined as the meeting point of the planes of the radial faces 15.

In the original cross-section of the segment, the radial faces generally formed a V-shape that converges at the apex 20.

The angle between the radial faces 15 is substantially less than 180 degree to form said wedge-shaped cross-section.

In FIG. 7, the original shape of the bark-edge of a wedge is shown by a curved dotted line 10A. The curved dotted line 10A generally indicates the contour of the curved bark-edge, which is the natural edge contour of the log.

In the original wedge (before it was pre-cut), the timber that was beneath and immediately adjacent the bark-edge 10A is regarded as the bark-edge-region. The present embodiment involves pre-cutting a shape and configuration in this bark-edge-region.

The shape and configuration, which is pre-cut into the bark-edge-region, includes the outer profiles of one or more the elongated timber-sections that would eventually be sliced from the elongated segment 11.

For example, in the cross-sectional view of FIG. 7, the pre-cutting step results in an upper ridge 110 that has had been pre-cut to create an edge-face-cut in the form of a bevelled edge-face 120B (“B” for bevelled). This edge-face 120B is transverse to the central-plane 100 of the wedge 10.

Also, the pre-cutting step provides the ridge 110 with other edge-face-cuts in the form edge-faces 120P (“P” for parallel) that are parallel to the central-plane 100 of the wedge.

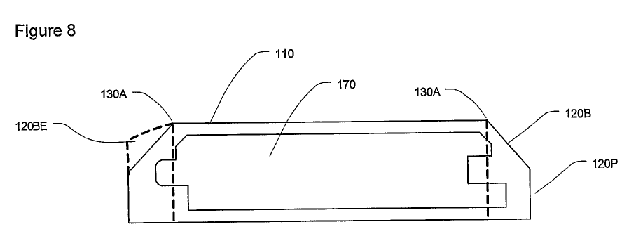

After the bevelled and parallel edge-faces 120B, 120P have been made, the wedge 10 is sliced along planes 130 that are perpendicular to the central-plane 100. This slicing converts the wedge 10 into a group of timber-sections. For example, the ridge 110, which was at the top of the wedge, eventually became a separate timber-section 110, shown separately in FIG. 8.

The timber-sections that are produced by the method of this embodiment have their cross-sections and edges already fully formed by virtue of the initial pre-cutting step.

In FIG. 7, the rectangular dotted outline 140 (which are inside the bark-edge-region above the ridge 110) indicates how a further smaller section of timber could be recovered from the section. That would require a further edge-face 120PP to be pre-cut in the bark-edge-region, prior to slicing.

In FIG. 7, other timber-sections 110A can be cut, to produce a plurality of timber-sections 110, 110A etc. from the one elongated segment of a log.

FIG. 8 shows a benefit of retaining a bevel edge-face 120B. The extra material that is contained in and around the bevel means that the overall timber-section contains more wood-material. This means that, if this piece were to be used as a floorboard, it could be used to cover a wide area. Also, the greater amount of wood-material means that the piece can be machined or shaped into a larger item. For example, FIG. 8 shows a solid outline of piece of flooring 170 that can be machined out from the timber-section. FIG. 8 illustrated that, if the timber-section 110 had not been provided with a pre-cut bevelled edge-face 120B, by cutting along the lines 130A, then the full piece of flooring 170 would not have been able to be made from this particular timber-section 110.

In the present embodiments, the direction of slicing 130 causes the growth rings 30. for the most part, to be very roughly parallel to the broad face of the timber-sections, to make sections that are basically backsawn. The term “backsawn” refers to when the growth rings are generally parallel to the broad face of the timber-section.

### 2^{nd} Embodiment

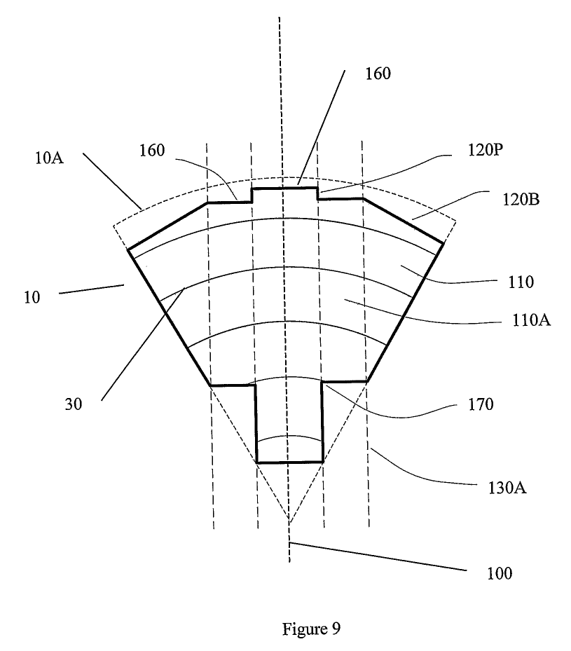

FIG. 9 shows a cross-sectional view of an elongated segment of a log, which has been pre-cut according to another embodiment of the present invention.

In FIG. 9, the original shape of the bark-edge of a wedge is shown by a curved dotted line 10A. The curved dotted line 10A generally indicates the contour of the bark-edge.

The present embodiment of FIG. 9 differs from the one on FIG. 8 in that the elongated segment, in FIG. 9, is to be sliced along lines 130A that are parallel to the central-plane 100. This results in a plurality of timber-sections 110, 110A etc. in which the growth rings 30 run transverse to the central-plane 100 of each timber-section.

In FIG. 9, the pre-cutting step results in the creation of bevelled edge-face 120B. This edge-face 120B is transverse to the central-plane 100 of the wedge 10.

Also, the pre-cutting step also creates edge-faces 120P (“P” for parallel) that are parallel to the central-plane 100 of the wedge.

In the second embodiments, the direction of slicing 130A causes the growth rings 30, for the most part, to be very roughly transverse to the broad face of the timber-sections to make sections that are basically quarter-sawn. In the language used by people in the industry, the term “quartersawn” refers to when the growth rings are basically at right angles to the broad face of the timber-section.

The timber-sections that are produced by the method of this embodiment have their cross-sections and edges already fully formed by virtue of the initial pre-cutting step.

### 3^{rd} Embodiment

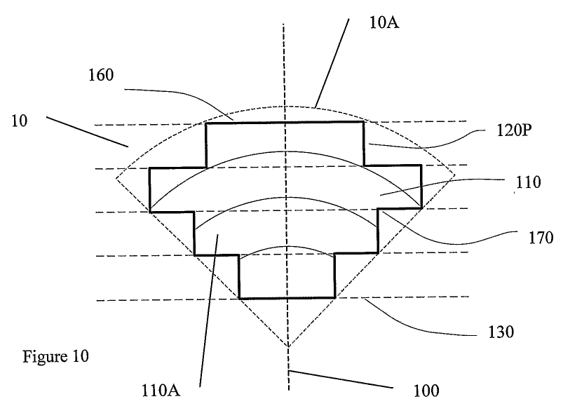

FIG. 10 shows a cross-sectional view of a modified embodiment of an elongated segment of a log, in that the pre-cutting step only results in the creation of edge-faces 120P (“P” for parallel) that are parallel to the central-plane 100 of the wedge.

In the embodiment of FIG. 10. the pre-cutting step does not create any bevelled edge-face 120B which are transverse to the central-plane 100 of the wedge 10.

The slicing of the elongated segment results in a plurality of timber-sections being created 110, 110A etc.

The timber-sections that are produced by this embodiment have their cross-sections and edges already fully formed by virtue of the initial pre-cutting step.

### Discussion About Edge-Faces

As indicated in the above, the important feature of the embodiments is the step of pre-cutting to create the edge-faces, which can either bevelled edge-faces 120B that are transverse be central-plane, or edge-faces 120P which are parallel to the central-plane. These edge-faces 120P, 120B are important because they eventually become the side-faces of the timber-sections, when the timber-sections are sliced out of the elongated segment 11 of the log.

Without the step of pre-cutting the bark-face-region to create these edge-faces 120P, 120B, it would be impossible to create the profiles of the elongated timber-sections which eventually are sliced from the elongated log-segment.

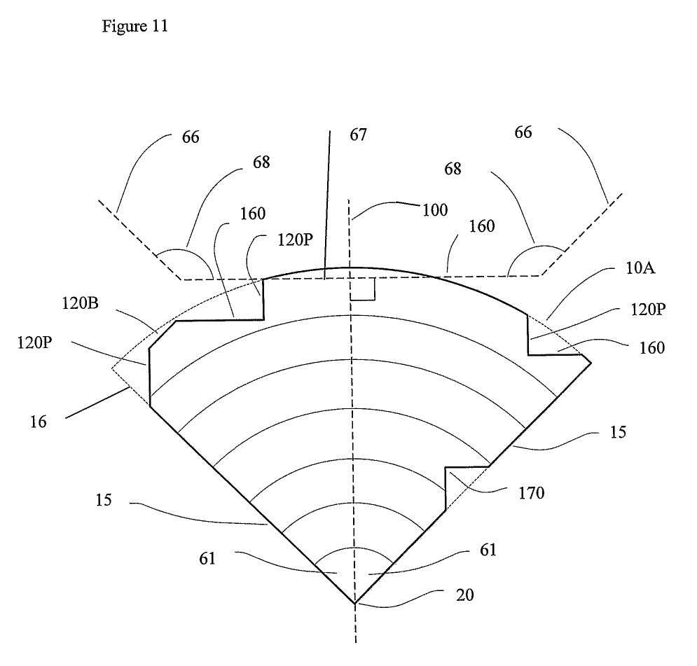

The angular orientation of these edge-faces can vary. FIG. 11 is used as an aid to define the permitted angles for these edge-faces 120P, 120B.

### Definition of the Angle of the Edge-Faces Made in the Bark-Edge-Region

FIG. 11 shows another embodiment of a cross-sectional view of an elongated segment of a log that is partially cut, in accordance with an embodiment of the invention.

In FIG. 11, the radial faces 15 of the wedge 10, and the planes 16 of the faces, meet at an apex 20.

A central-plane 100 divides the angle, which is between the two radial faces 15, which will be regarded as two equivalent angles 61.

The bark-edge 10A of the timber is shown in dotted lines.

The shape and configuration of the contours, that is pre-cut into the bark-edge-region below the bark-edge 10A, has a plurality of edge-face-cuts in the form of edge-faces 120B, 120P. The permitted angles, for the portions referred to as “edge-faces”, are not limited to how these appear in the drawings. In the invention, the orientation of the edge-faces is defined by the following:

i) the edge-face is not parallel to the radial faces; and

ii) the edge-face is not perpendicular to the central-plane that bisects the angle which is between the two radial faces.

Therefore, the edge-faces can be pre-cut into the bark-face-region at any angle, apart from the two parameters which are prohibited above.

Any pre-cut surface, which does not fit the above definition, is not regarded as an “edge-face”, for the purposes of this specification. (This description uses other terminology for those other surfaces that do not fall within the definition of i) and ii) above).

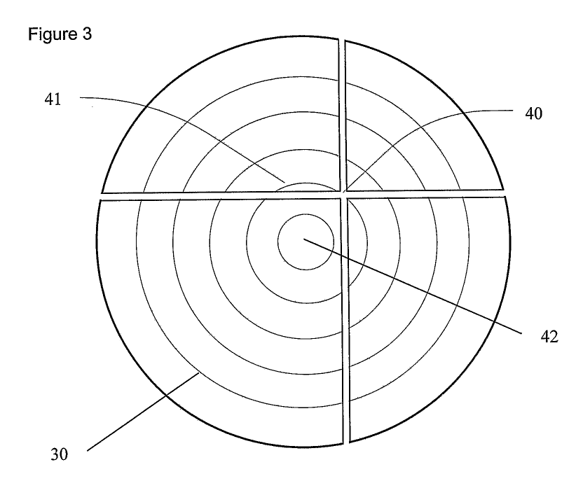

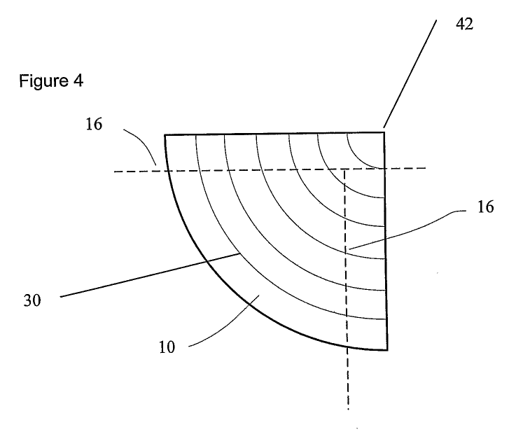

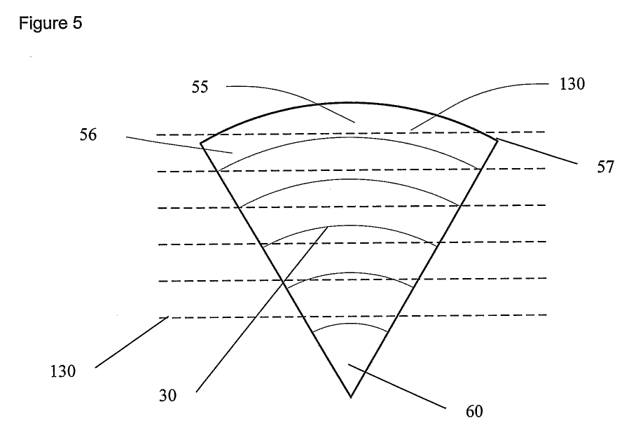

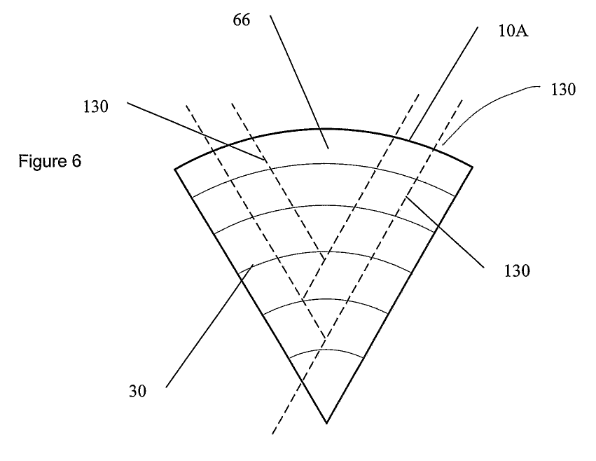

Since the definition of the permitted angles for the edge-faces is with reference to the radial faces, the definition also applies to those wedge-shaped cross-sections that do not include the true centre 42 of the axis of the tree, such as the wedges shown in FIGS. 3 and 4, for example.

The definition of the edge-faces is important because, as seen in FIGS. 7 and 8, these edge-faces, which are initially pre-cut into the bark-surface-region of the log segment, eventually become the edge-faces of the timber-sections, when the log segment is sliced up into the timber-sections. For example, in FIG. 7, the edge-face 120B becomes a bevelled edge in the final timber-section, in FIG. 8, that is sliced from the log segment.

In FIG. 11, an attempt has been made to draw dotted lines to indicate the prohibited angles.

In the diagram, the dotted lines 66 are each parallel to one of the radial faces 15, and hence the edge-faces 120 are prohibited from being in the orientation of the dotted line 66.

Also in the diagram, the dotted line 67 is perpendicular to the central-plane 100, and hence the edge-faces 120 are prohibited from being in the orientation of the dotted line 67.

The permitted angle, of each of the edge-faces (e.g. 120P, 120B) has to lie somewhere between, but not at, these two limits, namely the end-limits i) and ii) described above. These limits are shown by the dotted lines 66, 67 in FIG. 11.

The angle at the apex will determine the range of permitted angles of the edge-faces, since the permitted angles are defined with reference to the slope of the radial faces 15. Therefore, the invention and its embodiments are not limited to the angles shown by dotted lines in FIG. 11, since the permitted angles will vary if the angle at the apex 20 is changed. Theoretically, the angle of apex 20 could be anything up to slightly less than 180 degrees, for the segment to remain classified as having a wedge-shaped cross-section, although, in practice, the apex angle 20 will often be much less.

There is a technical explanation for this: the edge-faces 120 eventually become the edges of the timber-sections when these are sliced, and hence the edges-faces have to be of an orientation that would will produce an edge in the timber-section that is practically useful, and which avoids wastage.

In FIG. 11, the permitted angles, for the edge-faces, are shown to be in the angle between the dotted lines 66, 67.

For example, referring to the above definition, the parallel edge-faces 120P fall within the above definitions. As seen in the embodiments of FIGS. 7, 9 and 10, one or more of the edge-faces are parallel to the central-plane 100, and therefore do not infringe the above prohibitions.

The bevelled edge-faces 120B fall within the above definition, in that one or more of the bevelled edge-faces are not parallel to the central-plane 100.

As can be seen from FIG. 11, It is not necessary for the shape and configuration of the contours, that is pre-cut into the bark-edge-region, to be symmetrical about the central-plane 100.

There is another reason for avoiding the above angles defined in i) and ii) above. Those definitions prevent the edge-faces 120 from being parallel to the flat-faces 160. If the edge-faces 120 were to be parallel to the flat-face, there would be no edge at all, because it would be merely a continuation of the flat-face. Another reason is that, as the angle of the edge-face 120 approaches the plane of the radial edge, it increases wastage by going against the natural slope of the bark-edge.

### Partial Removal of Bark-Edge-Region Material

In some embodiments, it is permitted to pre-cut only the parallel edge-faces 120P, but to leave the bevelled edge-faces 120B still being made up of the natural bark-edge of the tree, as earlier defined. This is because, sometimes, the angle of the bark-edge, at that location, is suited to performing the function of a bevelled edge. In such cases, the end-user would have to machine off the bark during manufacture. For example, FIG. 8 shows a bevelled edge-face that has not been created by machining. Instead, the bevel is created by the natural curvature of the bark-edge. The bark-edge-region timber, which is under and adjacent to tire bark-edge, can be cut off during the machining operation when the required profile is machined into the timber-section.

### Flat-Faces and Notch-Faces

To complete the shape and configuration of the outer profiles of the timber-sections, the step of pre-cutting also creates flat-faces 160 that are perpendicular to the central-plane 100. The flat-faces are created by pre-cutting a plane in the bark-edge-region that is perpendicular to the central-plane, so as to create a flat-face on the bark-edge-region.

The step of pre-cutting can also create notches 170 in the radial faces 15 of the wedge-sections 10.

Examples of flat-faces 160 and notches 170 can be seen in the examples of FIGS. 7, 9, 10 and 11.

In the embodiments, the flat-faces 160 are not regarded as being the same feature as the edge-faces 120P, 120B, because the flat-faces are produced incidentally as part of the creation of the machined or cut-edge of the timber-section, and the flat-faces are further recreated during the subsequent sawing of the elongated segment to individual timber-sections. In contrast, the edge-faces 120 are created intentionally, with foresight, and are clone in a shape and configuration that will allow each to become an edge of a timber-section when slicing of the elongated segment occurs.

### Concurrent Cutting

In the examples of FIGS. 7, 9, 10 and 11, it is an advantage that more than one of the edge-faces are able to be concurrently pre-cut into the bark-edge-region at the same time.

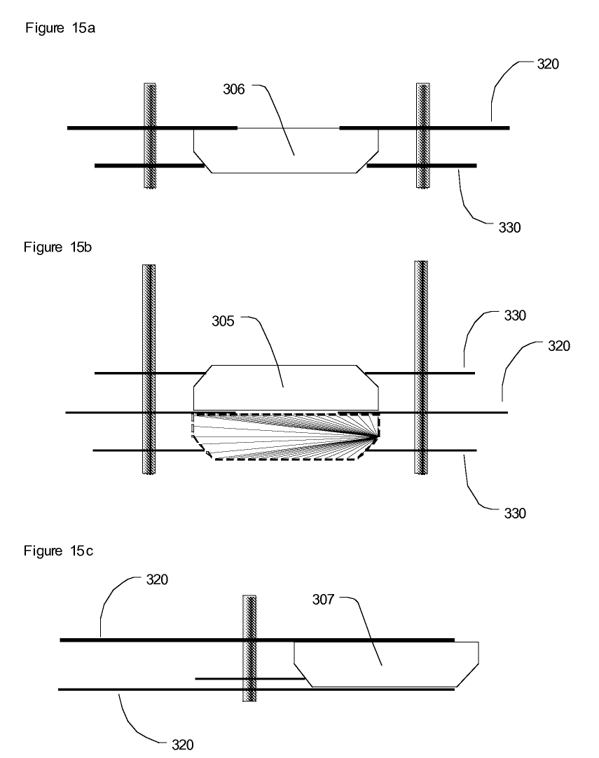

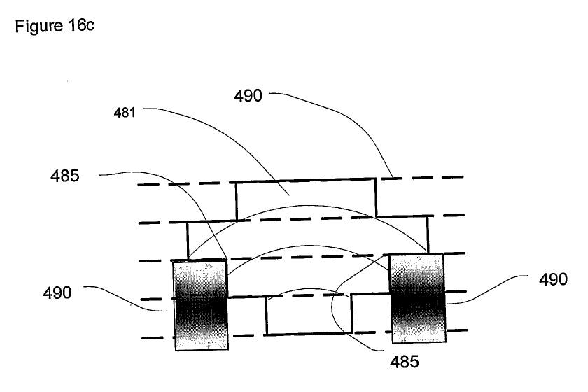

For example, a machine in FIG. 16 is adapted to pre-cut the bark-edge-regions of the wedge with just one pass of the elongated segment through the machine.

### Sequence of Cutting

The initial pre-cutting into the bark-edge-region of the elongated segment can occur either after the elongated segment has been cut out of its log, or before the elongated segment has been cut out of its log.

For example, a modification of the invention could involve prior-cutting the shape and configuration into the bark-surface-region of a log, while the cross-section of the log is still the generally circular shape of the tree trunk. After the shape and configuration has been pre-cut into the bark-face-region of the log, it is then divided into elongated segments having wedge-shaped cross-sections.

### Adapting the Method to Process Irregular Shaped Logs

As mentioned, an important feature of the present invention is the step of pre-cutting a shape and configuration into the bark-edge-region of part of a tree log. Natural tree logs are rarely perfectly cylindrical, and often have bends, curvature or other irregularities. These irregularities can be the result of growth stresses as the tree grows. Some trees, such as pine, tend to grow straight upright and hence tend to have fewer growth stresses in the timber material. Other types varieties of timber tend to have higher amounts of growth stress in the timber.

Therefore, further embodiments of the invention are adapted to pre-cut the bark-edge-region, while taking into account any irregularities in the linear shape of the elongated log segment.

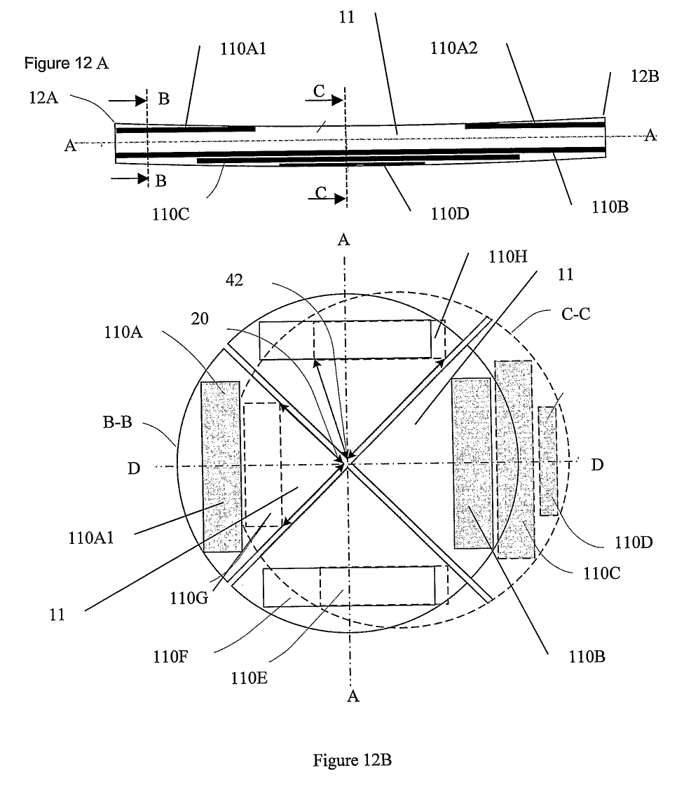

FIG. 12A shows a plan view of a log that is not perfectly straight. (For comparison, the central axis is shown as a dotted line A-A, and is a perfectly straight line).

FIG. 12B is a side-end view of the same log 11, viewed from the vantage-point of the end face 12A in FIG. 12A.

In FIG. 12B, the circle B-B represents the circumferential bark-edge of the log at the dotted line B-B in FIG. 12A, while the dotted circle C-C represents the circumferential bark-edge of the log at the dotted line C-C in FIG. 12A. This is because when the log 11 is viewed from the viewpoint of end 12A, one not only sees the cross-section at the end 12A, but also the curvature of the log.

In FIG. 12A, the dark linear areas in FIG. 12B represent timber-sections 110A, 110B, 110C, 110D that can be cut from the elongated wedge-shaped segments 11.

In FIG. 12A, due to the curvature of the log, the timber-section 110A1, which is close to the end 12A, can only be continued until about a third of the length of the log. A similar timber-section 110A2 can be cut from the other end 12B of the log where the curvature is similar.

In FIG. 12A, the timber-section 110B can stretch the full length of the log. Another timber-section 110C can only stretch around two-thirds of the log, and a further timber-section 110D, which is on the outermost part of the curvature of the log, can only extend for around a quarter of the length of the log.

In the side-end view of FIG. 12B, the end-views of these timber-sections 110A1, 110B, 110C, 110D are seen as shaded rectangles.

In FIG. 12B, a full-length timber-section 110E can be cut from the lower part of the log, since the profile of section 110E coincides with both the concentric circles B-B and C-C. Likewise, the timber-section 110G is able to run the full length of the log, because it coincides with both circles B-B and C-C.

In FIG. 12B, another section 110F cannot run the full length of the log since, at some parts along the log, the section 110F does not coincide with the cross section C-C.

For limber-section 110G, which is symmetrical about the horizontal axis D-D. the distance of its corners to the apex 20 of the wedge is equidistant for both of its corners. In contrast, for another timber-section 110H, which is offset from the central axis A-A, the distance of its corners to the apex 20 of the wedge is not equidistant for both of its corners.

### Linear Irregularities in Log Segments

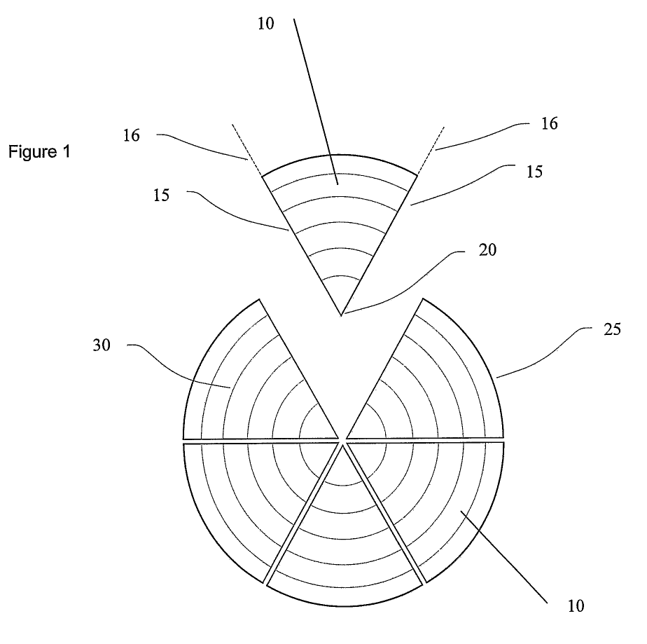

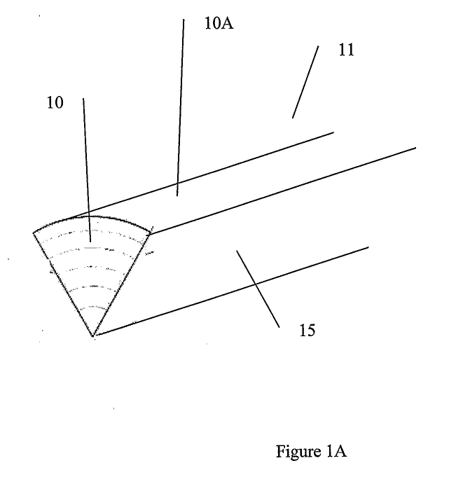

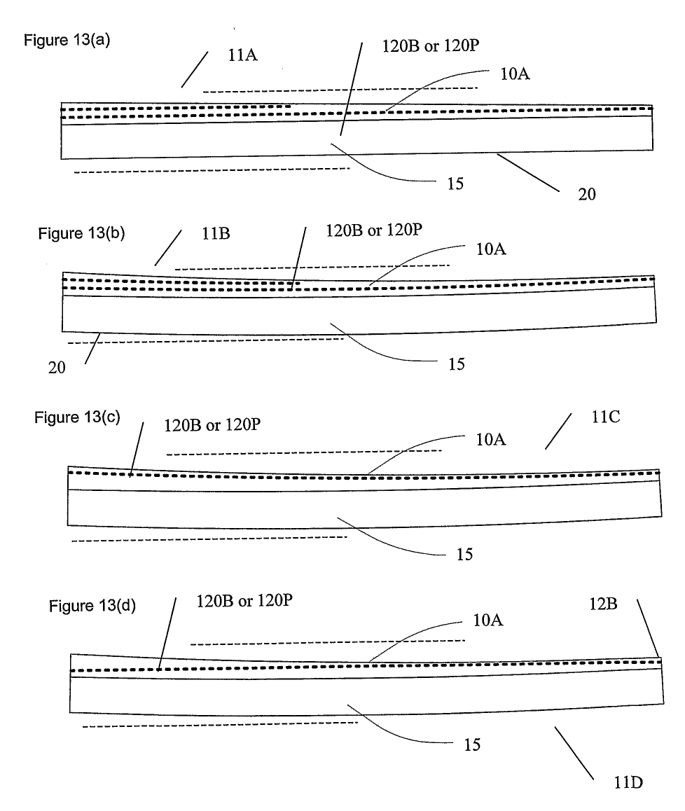

FIGS. 13A to 13D each show a side view of one of four imperfect, elongated log segment 11A, 11B, 11C, 11D that have wedge-shaped cross-sections 10, similar to the elongated log segment shown in FIG. 1A. The imperfections of these segments 11A-D relate to their imperfect linearity with respect to the longitudinal axis.

In each of FIGS. 13A-D, external dotted lines are provided as a visual point of reference.

Compare FIG. 1A with FIGS. 13A-D. The curved upper portion 10A represents the natural, curved bark-face 10A of each segment, while the sides of the wedge-shaped segments are in the form of radial sides 15.

Embodiments of the invention involve pre-cutting a shape and configuration into the bark-edge-region, in the timber under and adjacent to the bark-face 10A. Since, in FIGS. 13A-D, there are irregularities in the surfaces of the bark-faces, the embodiments in these figures show how edge-faces 120B or 120P can be pre-cut into these irregular bark-faces 10A. (In these diagrams, the edge-faces 120B, 120P are represented by short thick lines).

In the pre-cutting process, a cutting machine makes one or more passes along the entire length of the elongated log segments 11A-D. The cutting machine needs a reference point, with respect to the log segment, in order to accurately cut the edge-faces in the bark-edge-region 10A. Several physical features can be used as reference points, and each of FIGS. 11A-D shows a different type of reference point used for the step of pre-cutting.

Some options include the cutting machine following the linear curvature of the bark-edge. Another alternative is for the line of cutting can be made to be equidistant from the line of the apex of the radial faces. The alignment of the cutting machine is preferably controlled by computers.

FIG. 13A shows a log segment that is of a variety of timber, such as pine, that has no, or substantially little, growth stress in the timber. Consequently the apex 20 will be generally straight. Cutting machinery is used to pre-cut a series of edge-faces 120P or 120B in the bark-face-region. The edge-faces are pre-cut along the elongated segment such that the series of the edge-faces follows a line dial is parallel to the apex 20 along the length of the segment.

In FIG. 13A, at the thicker part of the log segment, which derives from a larger log diameter, a second series of edge-faces is created. The edge-faces in the first series are a step below the edge-faces of the second series. When viewed from a side-profile, the relationship between the edge-faces of the first and second levels appears as a step.

In contrast with FIG. 13A, the curvature in the log segments in the following FIGS. 13B, 13C and 13D are due to growth stresses, as opposed to being bent logs. (In contrast, a bent log, without growth stresses, would be tend to have a straight apex, and be concave or convex at the bark-edge surface).

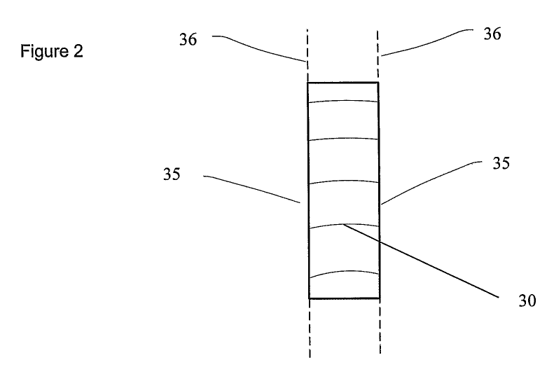

Thus, FIG. 13B shows a log segment, such as eucalypt hardwood, that has substantial growth stresses in the timber material. An effect of the growth stress is seen in FIG. 2, in that: i) the part of timber that is closest to the centre of the tree will tend to become convex, and ii) the part of the timber that is farthest from the centre of the tree-trunk will tend to become concave. As a result, the surface of the flat-faces can become curved.

In the embodiment in FIG. 13B, each of the edge-faces 120, which are pre-cut in the bark-face-region, have been pre-cut so as to be equidistant from the apex of the radial faces 15. Also, the edge-faces are-equidistant from the radial faces 15.

FIG. 13C also shows a log segment that contains growth stresses. The cutting machinery has also pre-cut the edge-faces 120B or 120P along an upwardly sloping line, except here the machine has followed a line that generally follows the curvature of the bark-edge 10A. Hence, in FIG. 13C, the edge-faces 120B or 120P are not necessarily or not always parallel to the apex 20 of the radial sides 15.

In FIG. 13C, the elongated segment has a bark-edge surface which has a longitudinal curvature along the elongated segment, and wherein the cutting apparatus is adapted lo make the plurality of edge-face cuts in the bark-edge-region along such that a series of the edge-face cuts are created along a line that follows the longitudinal curvature of the bark-edge surface.

In FIG. 13D, the cutting machinery has selected the end 12B of the log segment as the reference point, and has moved along a line starts at that reference point 12B and has moved across the log segment in a perfect horizontal path. The method in FIG. 13D is useful for removing those parts of the elongated segment that have considerable growth stress.

After the pre-cutting process of FIG. 13A to 13D has finished, next the flat-faces 160 and notches 170 can be created.

In FIG. 13E, a profiled wedge section is shown in side view. The diagram shows the dotted line profile of the bark-edge 210 from which the profiled section has been cut. A step has been made in the top flat-face to produce a short timber section 270 from the flared end of the wedge section. A short curved section 260 is shown where the flat face steps up to the next level. This curved section has been caused by the flat-face cutter which rotates around a horizontal axis, changing its cutting position to continue cutting at the next level. The flat-faces are parallel to the apex, except for the small transition area at the change of levels. The edge faces as shown are also parallel to the apex. Lines 260 indicate where the cutters, which rotate around a vertical axis, were shifted closer to the central plane of the wedge-section in order to cut a narrower section on the second timber section level.

Dotted lines 220, 230, 240 indicate the associated cross-sections below. These associated cross-sections show the profile of the profiled wedge-section at that point. The offset edge-faces 280 show how the edge-face cuts do not have to be equidistant from the dividing plane of the wedge-section.

For wedge sectors, or parts of wedge sections where the bulk or more of the timber is offset to one side of the dividing plane of the wedge section then the off-setting of the edge-faces and associated-flat faces enables maximum timber recovery from those areas.

### Transfer Apparatus

The cutting apparatus has simultaneous-pre-cutting-means which is used to concurrently make two or more of the edge-face cuts.

The cutting apparatus has simultaneous-pre-cutting-means which is used to concurrently make all the edge-face cuts in one pass of the apparatus along the elongated segment.

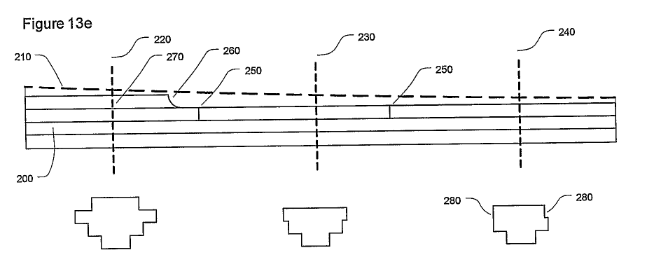

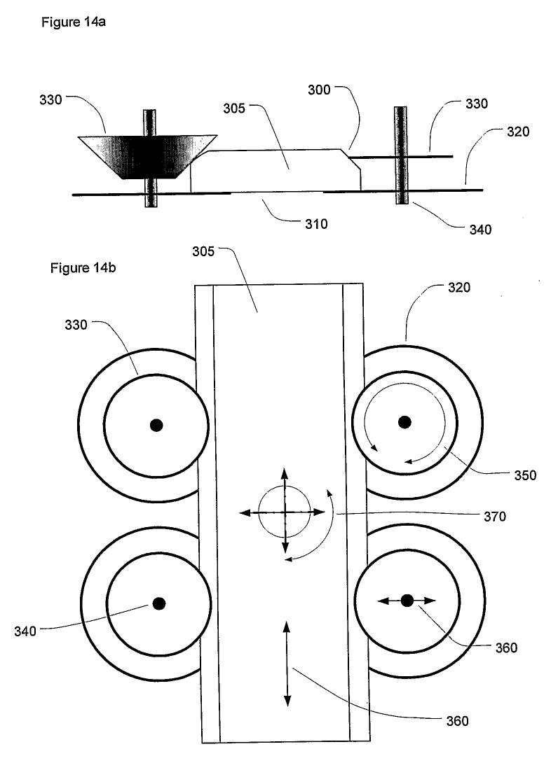

FIGS. 14a and 14b show a device that transfers and sorts timber-sections that are produced by the method embodiments.

The device reduces the manual handling that is required in the production process. The device also speeds up the process. Timber-sections can be heavy. Continuous lifting of these timber-sections can be tiring, and can sometimes lead to injury.

In FIG. 14a, a timber-section 305 is held by flat disks 320 that contact the flat-face of the timber-section 310. The diagram also shows disks or cones 330 that contact the edge-face of the timber-sections.

The cone 330 is particularly advantageous when used to contact timber-sections that retain the bark-edge sections, that are fully rectangular or that are inverted, such that a fully square edge of the timber-section contacts the cone 330.

In FIG. 14a, a disk and cone are mounted on an axle 340. In other embodiments, the two disks may be used instead.

The axle 340 allows the disks and cones to rotate, as shown by arrow 350. The two disks, or a disk and cone, and the axle are hereinafter referred to as an assembly. Rotation of the assembly, in contact with the timber-section, causes the timber-section to travel in the required direction, relative to the assembly, as shown by arrow 360 in FIG. 14b.

The disks that contact and drive the edge-face of the timber-section may be serrated to assist with driving the timber-section. Likewise, the cone may be serrated. Alternatively, the cone may be made from a rubber or synthetic material to drive, but not damage, the timber-section.

The assemblies generally operate opposite to each other, or opposite and offset to each other on either side of the timber-section 305, as seen in FIG. 14b.

The assemblies can be mounted on fixed supports or in groups of two or more on a support that can travel, move and rotate as required in directions as are indicated by the arrows 370.

The assemblies of the group can be made to move towards or away from each other, so that timber-sections of different widths can be gripped.

In addition, the group can be made to go up or down, and to raise or lower the timber-section as required.

There are alternative to the embodiments of FIGS. 14A and 14B. For example, FIGS. 15A, 15B and 15C show alternative embodiments that use disks to contact the edge-faced of the timber-sections. Although not shown, the figures and references equally apply to the cones, where appropriate.

FIG. 15a shows an assembly where the disk 330, which contacts the edge-face of the timber-section, is mounted below the disks 320 that contacts the flat-face of the timber-section. This configuration allows for the lower edge-face disk to contact the bevelled portion of the radial face of a timber-section formed by slicing through a timber section profiled with an edge-notch. The upper and wider flat face of the timber section contacts the upper flat-face disk.

In FIG. 15b, an assembly is shown with additional disks which contact the edge-face, so that either the bark-edge or the radial-edge timber-sections can both be handled by the one assembly, at different times.

In FIG. 15c, both the flat-faces of the timber-section 307 (which can have any edge-face profile) can be contacted to allow the assemblies, which are mounted on one side on the section, to control the timber-section. This embodiment allows for the timber-section to be moved sideways away from the assemblies.

All the above embodiments of the transfer and holding devices can grip and transfer triangular wedge-sections. Where appropriate, these devices can also restrain, control or hold the straight sections of timber that are effected by growth stresses.

While FIGS. 14 and 15 show flat-faces that are horizontal, the flat-faces and devices could also be aligned in any plane.

Also, the alignment of the flat-faces and the assemblies could change, or be changed, during the transfer of the timber-section.

### Production of Profiled Wedge-Sections

FIGS. 16A, B and C show apparatus that produce the profiled wedge-sections of timber, and which also slice the profiled sections to produce the individual timber-sections.

In the prior art, the manufacture of individual timber-sections requires a number of separate steps. For example, after the wedges are produced, they can be re-sawn into individual sections by multiple saws that cut in one pass. Alternatively, the production can involve repetitively passing the wedge through a single saw.

As a by-product, these prior art operations produce many small timber-sections that are too thin to be useful.

In this prior art method, all the unusable pieces of off-cut timber have to be sorted, handled and carted away as waste, or transferred to a wood chipper. These prior art methods also produce many timber-sections, some of which require three passes of the saw, and also rely on the judgement and skill of the operator, before they can be made into useful timber.

Often, the time and expense needed to re-saw these large amounts of off-cuts and boards cannot be justified from a commercial perspective. In such cases, the large amount of off-cuts present a problem of waste disposal. Stopping and starting of different operations is disruptive to smooth production.

In the prior art, if wider boards are required from small or equal size logs then a wider wedge must be cut to produce the wider board. In the re-sawing of wide wedge sections to backsawn boards there is a greater proportion of the timber in the bark edge area. This means more cutting and edging of timber sections with no defined or straight side faces. This means there is extra work involved in removing the higher number of bark-edges from the timber sections and more possibility for wastage if the bark-edges are not removed accurately.

Generally these prior art operations are slow and labour intensive, and are rarely worth the effort in view of the amount of extra timber that is produced.

In contrast, in a preferred embodiment of the present invention, a production sawing apparatus is able to reduces or ameliorate the problems in the prior art.

The wedge-section profiling and slicing machine cuts all required edges to the required finished green size ready for docking and direct use, or docking, stacking and drying prior to further processing. In this preferred embodiment, woodchips can be cut directly from the waste portion of the wedge-section and transferred away. There is no manual handling of waste pieces or sections of limber that need to be further processed.

The process avoids manual handling at the sawing and production stage. It allows for high speed and uninterrupted production.

The accurate positioning of production cuts allow for tine maximum amount of timber to be produced at a minimum of extra cost.

In the preferred embodiment, the required number of cutters is positioned so that all the cuts can be made in one single pass and in the required position.

The required position for the cutters is determined by scanners and computers that are linked to actuators. The actuators position the cutter so as to maximize production.

The cutters are adjustable. The position of the cutters can be varied in the pass of an individual wedge-section, so that the timber gain can be maximized from variation in the profile of the bark-edge of the wedge-section.

In FIG. 16a, the cutting devices 400, 410 and 420 are used to cut edge-faces 430, flat-faces 440 and notch faces 460 into the wedge-section 450 in the required positions.

In FIG. 16a, the cutter 410 rotates around a horizontal axis. The other cutlers 400, 420 rotate around a vertical axis.

In other embodiments, the wedge could be aligned at a different angle, and the cutters would similarly be aligned at different angles.

For example, a wedge-section with a 90 degree angle between the radial faces could be inclined so that one radial face was horizontal. In this case, the face cutter 410 would be inclined 45 degrees from the horizontal to cut the top flat-face 440.

In FIG. 16a, the cutters are merely examples of cutter position and number. Different configuration of cutters can achieve the same result. Horizontal axis cutters could, for example, cut the notch-face 460. Vertical axis cutters could cut the top flat-face 440.

Cutters can be adjusted in the vertical and horizontal planes, as indicated by the double ended arrows in the diagrams.

Bevelled edge-faces can be cut by a winged cutler 420 that matches the require profile. Alternatively, the bevelled edge-face may be cut with a straight cutter that rotates around an angled axis.

It may not be necessary to have a cutter specifically to cut the angle and the extra bark-edge timber from the bevel, particularly in operations where the timber-section will be dried and machined and where the extra timber contained within the bevel can be used. If the minimum bark-edge timber meets the requirements of further machining, the extra bark-edge timber can be deemed to have been removed, and the actual extra timber can be removed during the subsequent machining.

Cutters can be staggered along the length of the section to provide clearance for mounting and driving means. The actual number of cutters can be varied to achieve the required result.

Near the apex, cutters may be fixed or minimally adjusted, since there would be a minimum wedge-section size where all wedge-sections would produce a minimum cross section size.

The cutters can be set up to cut wood chips suitable for paper or other uses.

The cutter position could be adjusted manually. Alternatively, electronic data can be fed to appropriate mechanical actuators that can position the cutting devices. The electronic data could be collected by scanning the bark-edge, the radial faces and/or the ends of the log.

Cutting devices could be fitted to the sawing mechanism that cuts the logs into the wedge-section, so that the edge-faces or the flat-faces are machined into the log before the wedge-sections are cut from the log.

Once the wedge-section has been cut to the required profile, the wedge-section can be sliced into timber-sections by a sawing device. The sawing device is able to cut multiple slices in one pass. Alternatively, the profiled wedge-section can pass through individual sawing stations, which slice one timber-section at each station.

Sometimes, cuts may be made that are sufficient to profile one timber-section, and a timber-section is sliced from the wedge-section before the process is repeated.

In certain circumstances, it is desirable to cut edge-faces at different cutting stations. In the embodiment, at least two edge-face cuts would be made at each station.

In FIG. 16b the radial faces 465 are referenced by rollers 470 to align the section in the required position for the cutter 480. Other roller types could be used than those illustrated. If the rollers are moved in the direction of the arrows 475 the section will move up and down in relation lo the cutler as shown by the arrow 476. For example if the rollers are moved in or out the wedge-section will move up and down. If the position of the rollers are maintained while the section is cut (and the cutter position is maintained) then the distance from the apex to the edge-face will be constant.

If the position of the rollers is shifted, the distance of the edge-face to the apex will be varied relative to the amount the rollers are shifted or adjusted.

The reference roller position could be adjusted manually or electronic data could be fed to appropriate mechanical actuators to position the cutting devices. The electronic data could be collected by scanning the bark-edge, the radial faces and/or the ends of the log.

The rollers can be adjusted during the passage of a wedge-section so that; the cut faces are basically along or on a flat plane; or the cut faces basically follow the bark-edge-face which may be on a flat plane or on a curved plane caused by growth stresses or a bent log.

In FIG. 16c the apparatus references the notch-faces 485 to make the subdividing cuts 490 after the faces have been profiled into the wedge-section 481.

If the cuts made in the section do not follow or are not consistent with the radial faces the radial faces can no longer be used as the reference for the subdividing cut. In this circumstance, and while FIG. 16c shows a wedge-section which has been profiled with full notch-face cuts, this need to follow profiled faces also applies if part or the radial faces still remain.

In certain applications it may also be desirable to reference other profiled faces than the notch faces to facilitate the slicing process.

In a preferred embodiment a system is provided for the automated and/or efficient docking, sorting and stacking of the timber-sections.

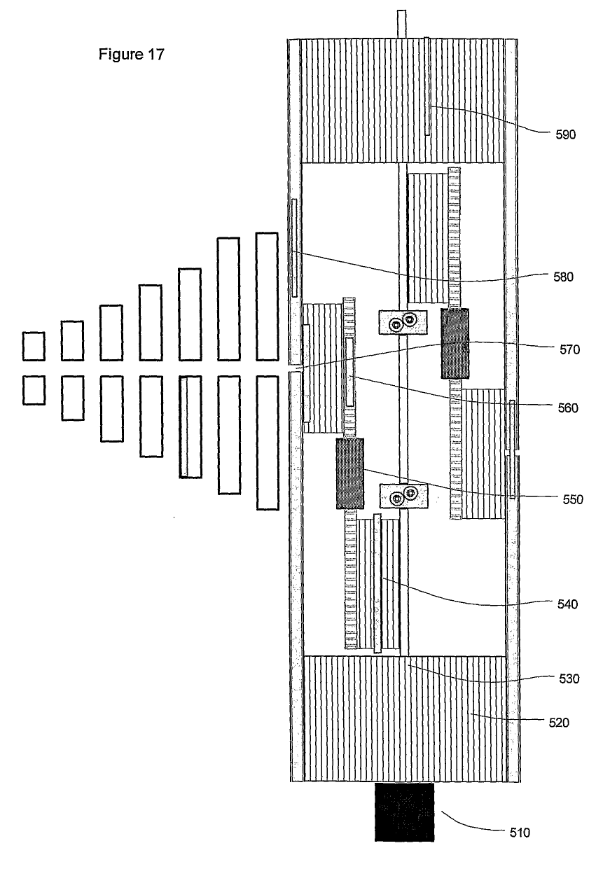

FIG. 17 shows the layout for a preferred embodiment of the system. The figure shows a small part of a complete system.

In conventional milling a large percentage of the work in a sawmill in producing sawn timber takes place in the docking, sorting and stacking of the timber once it has been cut.

The present system allows for the efficient production accorded by the embodiment to be fully exploited.

in FIG. 17, wedge-sections that have been scanned and assessed are machined to an optimum profile on the apparatus 510. The profiled section passes a sawing station 530, which in this instance may be located under the timber-section conveyor 520, The sawing station saws the first timber-section from the top or bottom of the wedge. The sliced timber-section is transferred in a transverse direction away from the sawing line on the conveyor as shown 520. It is then moved parallel to the sawing line through a docking station which may be manually operated or an automatic scanning docking apparatus. According to the embodiment when a timber-section leaves the sawing station the section could contain multiple widths. The docking station can cut multiple width sections into single width sections and also remove defective timber.

The docked timber leaves the docking station 560 and then travels transversally to a pick up station 570. At the docking station additional data about the timber-section can be collected after docking. In the automated system it is anticipated that all data would be known about timber-section length and width but the data needs to be upgraded after docking. Keeping track of all data and timber positions allows for a computerized system to know where each timber-section is at all times and where it will end up in the soiling system.

At the pickup station 570 the timber-section, if it is the right width for that station, can be picked up by the transfer device referred to prior in this specification and stacked in individual length packs. If the section is not of the right width for the pickup station the section can be conveyed parallel to (580) the sawing line and transversally to (59) the sawing line until it reaches the correct pickup station that matches board width. At certain stages the limber-section may travel in a direction opposite to the direction of travel of the saw line so that, effectively, the sections travel in a circular pathway around the sawing line. When a timber-section reaches a pickup point the transfer device may be occupied transferring another section. The section could be made to do one or more full circuits of the conveying system so that the section arrives at the pickup point when the transfer device is available to remove and stack the section.

To facilitate this, the whole system may operate in timed stops and starts. The end transverse conveyors can be used to hold and release sections to the lineal conveyors at the required time so that the section arrives at the pickup station at the required time.

FIG. 17 only shows a small aspect of the system which generally would have many sawing, docking and stacking stations. Also a system does not need to entail all aspects as disclosed and some operations could be done manually. It may be preferable to instigate certain aspects of the embodiment via manual operations and convert to automated aspects and extend the aspects as the operation develops.

The embodiment has for its object the production of timber-sections. These timber-sections have a multiplicity of uses. These sections offer usage normal to all timber products but also offer increased usage by the economical production of a bevel edge-face that can provide for effective extra cover or machining width for subsequent product manufacture.

The product laminated from the sliced profiled sections has the potential to solve many problems facing the sawing of the eucalypt tree which is the world's most common plantation tree. Many of these plantations have been grown for pulpwood and generally do not produce good quality wood because of knots and high growth stresses. The wood that can be sawn from these trees is of low value so the method of sawing, as is provided by the present embodiment, must be economic. The following aspect of the embodiment allows for economic production and increased value of product output.

All timber-sections sliced from the profiled wedge-section have a high degree of consistency of growth ring orientation whether quartersawn sections or backsawn sections. Triangular quartersawn timber-sections are ideal to laminate to a rectangular or square section and parallel sided backsawn sections are also ideal for laminating.

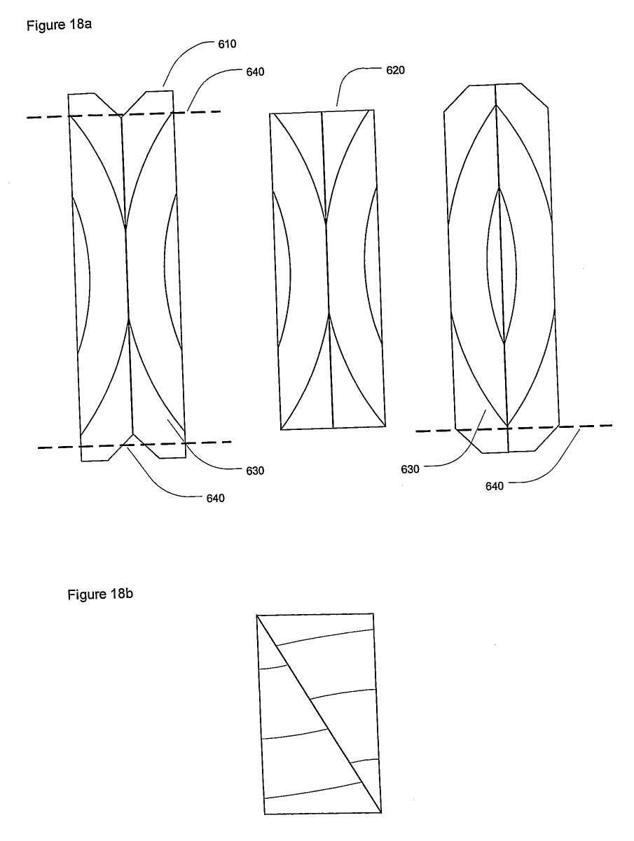

FIG. 18a shows backsawn timber-sections laminated or connected together. Annular rings 630 can be opposed to balance the natural cupping tendency of the backsawn boards. The natural tendency is for the section to cup so that the side that was closest to the heart of the tree becomes convex and the side that was farthest from the heart of the tree becomes concave. Opposing the growth rings as shown will produce a more stable timber-section. Connection can be by gluing or other means normal to connecting timber such as nailing.

Also growth stresses cause the longitudinal length of timber to move away from the centre of the tree. The flat-face of a backsawn board that was closed to the centre of the tree and that has not been cut straight or is not held straight will be convex along its length and the side farthest from the center will be concave. Opposing the growth rings also opposes the curvature caused by growth stress so a straight laminated section of timber can result.

Additionally the backsawn section of timber is stronger under load so the laminate had that additional advantage, and as the lamination is vertical and parallel to the main load forces, the laminate does not have a tendency to separate the glue line.

Also the laminate has the advantage that knots can be randomized in the laminate so that even knotty timber has the possibility of making strong timber.

In FIG. 18a the edge-faces 620 of the embodiment and dotted lines show how bevelled edge-faces can be cut off for a standard rectangular section. Alternatively only part or none of the bevelled edge-face may be cut off.

FIG. 18b shows a quartersawn laminate produce by connecting two triangular sections as shown by the section 110 in FIG. 9.

In the specification, the term “pre-cut” or “pre-cutting” refers to the step of cutting the shape and configuration into the into the curved bark-edge-region before the wedge is sliced into timber-sections.

The words “cut” or “pre-cut” are not limited to a particular manner of achieving the shape and configuration, and this can be achieved by milling, grinding, sawing or other shaping operation that produces the desired shape and configuration.

Likewise, the “slicing” of the timber-sections can be achieved by a wide range of cutting apparatus. For instance, in the embodiments, the step of slicing is achieved with by sawing the wood.

The embodiments have been advanced by way of example only, and modifications are possible within the scope of the invention as defined by the appended claims.

In this specification, where the words comprise or comprises or derivatives thereof are used in relation to elements, integers, steps or features, this is to indicate that those elements, steps or features are present but it is not to be taken to preclude the possibility of other elements, integers, steps or features being present.

1-49. (canceled)

50. A method of using a cutting-apparatus to cut a plurality of elongated timber-sections from an elongated log-segment that has a wedge-shaped cross-section defined by two non-parallel radial faces with an angle therebetween bisected by a central-plane, and that also has a curved bark-edge-region, the method comprising the steps of:
initially pre-cutting, into the bark-edge-region, a shape and configuration that includes outer profiles of one or more elongated timber-sections that eventually will be sliced from the elongated log-segment,
and slicing the elongated log-segment such that the timber-sections so produced have their cross-sections and edges already fully formed by said initial pre-cutting step,
wherein the shape and configuration that is pre-cut into the bark-edge-region, comprises a plurality of edge-face-cuts that are defined by one or more of the following:
i) the edge-face-cut is not parallel to the radial faces; and
ii) the edge-face is not perpendicular to the central-plane that bisects the angle which is between the two radial faces.

51. The method of claim 50, wherein one or more of the edge-face-cuts are parallel to the central-plane of the wedge-shaped cross-section.

52. The method of claim 50, wherein one or more of the edge-face-cuts are not parallel to the central-plane of the wedge-shaped cross-section.

53. The method of claim 52, wherein more than one of the edge-face cuts are concurrently pre-cut into the bark-edge-region.

54. The method of claim 53, wherein the cutting-apparatus has simultaneous-pre-cutting-means to concurrently make two or more of the edge-face cuts.

55. The method of claim 54, wherein the simultaneous-pre-cutting-means of the cutting-apparatus can concurrently make all the edge-face cuts in one pass of the apparatus along the elongated log-segment.

56. The method of claim 55, wherein the initial pre-cutting into the bark-edge-region of the elongated log-segment can occur either after the elongated log-segment has been cut out of its log, or before the elongated log-segment has been cut out of its log.

57. The method of claim 56, wherein the radial faces generally form a V-shape that converges at an apex.

58. The method of claim 57, wherein the apex may or may not be physically present depending on the quality and condition of the wood material.

59. The method of claim 58, wherein the angle between the radial faces is substantially less than 180 degree to form said wedge-shaped cross-section.

60. The method of claim 59, including pre-cutting one or more planes in the bark-edge-region that are perpendicular to the central-plane so as to create one or more flat-faces on the bark-edge-region.

61. The method of claim 60, wherein the edge-face-cuts are adapted to become square-edges and/or bevelled-edges in the resulting timber-sections.

62. The method of claim 57, wherein the cutting apparatus is adapted to make the plurality of edge-face cuts in the bark-edge-region along the elongated log-segment such that each in a series of the edge-face cuts follows a line that, along the length of the elongated log-segment, is equidistant from the apex.

63. The method of claim 57, wherein the cutting apparatus is adapted to make the plurality of edge-face cuts in the bark-edge-region along the elongated log-segment such that each in a series of the edge-face cuts follows a line that, along the length of the elongated log-segment, is parallel to the apex.

64. The method of claim 61, wherein the elongated log-segment has a bark-edge surface which has a longitudinal curvature along the elongated log-segment, and wherein the cutting apparatus is adapted to make the plurality of edge-face cuts in the bark-edge-region along the elongated log-segment such that each in a series of the edge-face cuts follows a line that, along the length of the elongated log-segment, follows the longitudinal curvature of the bark-edge surface.

65. The method of claim 64, wherein the flat-face on the same log-segment is stepped and the stepped flat-faces are parallel to, but at different distances from said apex.

66. The method of claim 65, wherein the edge-faces are equidistant, along the length of the elongated wedge-section from said apex.

67. The method of claim 66, wherein the flat-face is not equidistant, along the length of the elongated log-segment, from said apex, and wherein the flat-face follows a path that is defined by the shape of the bark-edge or by any defect near said apex.

68. The method of claim 65, wherein the edge-face is not equidistant, along the length of the elongated log-segment, from said apex, and wherein the edge-face follows a path chosen for the flat-face.

69. The method of claim 68, wherein the cutting apparatus is provided with distance-variation-means that enables the distance of the flat-faces and of the edge-faces from said apex to be varied by moving the radial reference devices apart as the cuts are being made.

70. The method of claim 69, wherein, in the cutting apparatus, the distance of the flat-faces and of the edge-faces from said apex is varied by moving the radial reference devices up or down as the cuts are being made.

71. The method of claim 70, wherein notch-faces follow the edge-faces and the flat-faces, and wherein the notch-faces are either equidistant or not equidistant from said apex.

72. The method of claim 71, wherein when two or more of the edge-faces are made on the same log-segment of timber at one time.

73. The method of claim 72, including the step of cutting into the timber that is adjacent to the radial faces to make the notch-faces.

74. The method of claim 73, wherein the creation of the notch-faces causes the removal of all of the radial face on a timber-section

75. The method of claim 73, wherein the notch-face retains part of the radial face on a timber-section

76. The method of claim 75, including the use of the notch-faces as a reference point for creating the faces of further subdivisions.

77. The method of claim 76, including the use of mechanical, visual or electronic means to collect information about wedge segment, at any stage of its production process, and using the collected information to position the edge-faces in a manner that is particular to the nature of the timber.

78. The method of claim 77, wherein an edge-face is made on one portion of the log-segment and at another portion of the same segment,
and wherein the cutting means moves either towards or away from the central-plane and moves perpendicular to the central-plane in order to make bark-edges that are different distances apart along the length of the elongated log-segment.

79. The method of claim 78, including a step of sub-dividing the log-segment with the edge-faces.

80. The method of claim 79, including the step of sub-dividing the log-segment in one pass.

81. The method of claim 80, including the act of sub-dividing the log-segment and removing the timber-sections in multiple passes.

82. A timber-section produced according to the method of claim 81 wherein the timber-section is produced by the division of the wedge-section into timber-sections.

83. A cutting apparatus adapted to perform the method of claim 81, wherein the cutting apparatus comprises a disc that contacts and restrains the subdivided face and has a grabbing-or-driving means that contacts the edge-face.

84. The cutting apparatus of claim 83, wherein the apparatus causes the timber-section to travel lineally or to rotate.

85. The cutting apparatus of claim 83, wherein the apparatus is adapted to move relative to the wedge-section.

86. The cutting apparatus of claim 83, wherein the wedge-section is adapted to move relative to the apparatus.

87. The cutting apparatus of claim 83, wherein the apparatus is able to cut the edge-faces into the log before the wedge-section is formed.

88. A cutting system for cutting and sorting timber-sections in which the timber-sections travel transversally to the lineal cutting line and can be made to travel in both direction parallel to the lineal cutting line.

89. The system of claim 88, wherein the timber-sections travel transversally to the lineal cutting line and parallel to the lineal cutting line to move in one direction around the lineal cutting line.

90. The system of claim 89, wherein the system includes docking stations to separate timber-sections of different widths and remove defects.

91. A cutting system adapted to cut a plurality of elongated timber-sections from an elongated log-segment that has a wedge-shaped cross-section defined by two non-parallel radial faces with an angle therebetween bisected by a central-plane, and that also has a curved bark-edge-region, the system comprising:
pre-cutting-means adapted to cut, into the bark-edge-region, a shape and configuration that includes outer profiles of one or more elongated timber-sections that eventually will be sliced from the elongated log-segment, and
slicing-means adapted to slice the elongated log-segment such that the timber-sections so produced have their cross-sections and edges already fully formed by said initial pre-cutting step,
wherein the pre-cutting-means is adapted to cut the shape and configuration in the form of a plurality of edge-face-cuts that are defined by one or more of the following:
i) the edge-face-cut is not parallel to the radial faces; and
ii) the edge-face is not perpendicular to the central-plane that bisects the angle which is between the two radial faces.

92. The cutting system of claim 91, wherein the system is adapted to pre-cut into the bark-edge-region according to the method of claim 81.

93. A timber-product comprising at least two timber-sections that are sliced from an elongated log-segment according to the method of claim 81, wherein broad faces of the two timber-sections are fastened together such that the growth rings of each timber-section are opposed to the other in order to counteract any cupping tendency in the material of the timber-sections.

94. The timber-product of claim 93, wherein the timber-sections have growth rings that are generally transverse to the broad face of the timber-section.

95. The timber-product of claim 93, wherein the timber-sections have growth rings that are generally parallel to the broad face of the timber-section.

96. The timber-product of claim 95, wherein the growth rings of the two timber-sections are symmetrically opposed to each other in terms of direction of curvature of the growth rings, and not in terms of mirror-like identicalness.

97. The timber-product of claim 96, wherein the growth rings have a generally concave arrangement such that the concave portions of the two timber-sections symmetrically face each other.

98. The timber-product of claim 96, wherein the growth rings have a generally concave arrangement such that the concave portions of the two timber-sections symmetrically face away from each other.

99. The timber-product of claim 98, wherein the two timber-sections are fastened together by any one of: glue, adhesive, nails, screws, or other mechanical or chemical fastening means.
